(19) United States
(12) Patent Application Publication
(10) Pub. No.: US 2012/0033676 A1
(43) Pub. Date: Feb. 9, 2012

(54) MGCP PACKAGE FOR BATTERY BACKUP CONTROL

(75) Inventors: Satish Kumar MUNDRA, Germantown, MD (US); Tinku MANNAN, Potomac, MD (US)

(73) Assignee: TEXAS INSTRUMENTS INCORPORATED, Dallas, TX (US)

(21) Appl. No.: 12/849,419

(22) Filed: Aug. 3, 2010

(51) Int. Cl. H04L 12/56

(52) U.S. Cl. 370/401

(57) ABSTRACT

In one embodiment, a gateway includes an interface, and a processor cooperatively operable with the interface to transmit and receive packet communications. The processor receives, over the interface, a request-notification for a backup battery status, which is formatted according to a media gateway control protocol (MGCP) package protocol. The processor transmits, over the interface, a notify of an observed event, the observed event indicating the backup battery status which is formatted according to the MGCP package protocol. In another embodiment, a call agent includes an interface and a processor. The call agent processor transmits a request-notification for a backup battery status, which is formatted according to a media gateway control protocol (MGCP) package protocol. The call agent processor also receives a notify of an observed event over the interface, the observed event indicating the backup battery status, which is formatted according to the MGCP package protocol.

### TECHNICAL FIELD

The technical field relates in general to voice over packet communication networks, and more specifically to media gateway control protocol (MGCP).

### BACKGROUND

Media gateway control protocol (MGCP) is a master/slave protocol where control resides with the call agent and the gateway is the slave. Basically, the gateway responds to the commands from the call agent. The protocol defines some basic commands, such as create connection, modify connection, delete connection, and so on. These are defined in a basic protocol RFC. In short, the gateway acts as a dumb slave device with respect to the call agent which acts as a master; the gateway can only respond to what the call agent requests.

The conventional gateway can include a battery backup unit (BBU), and the gateway can track information about the battery, such as operating on backup power, or battery malfunction, and the like. The conventional gateway has information such as, how much is the charge, whether the BBU is functioning or not, and/or whether the gateway is on battery power or AC power, and the like. Those events are available at the gateway.

Actions can be taken by the gateway to conserve battery power, such as operating at a low duty cycle. However, the gateway cannot unilaterally take actions to conserve battery power particularly where they affect interaction with the call agent because the call agent controls the connection establishment and all of the parameters that go with it. If the gateway would unilaterally take actions to conserve power, the call agent might determine that there was an error with the gateway.

### SUMMARY

Accordingly, one or more embodiments provide an apparatus, method, system or computer readable medium storing instructions for a gateway and/or a call agent.

According to an embodiment, a gateway device, includes an interface; and a processor cooperatively operable with the interface to transmit and receive packet communications over a communication network. The processor is configured to receive, over the interface, a request-notification for a backup battery status, the request-notification being formatted according to an media gateway control protocol (MGCP) package protocol, and to transmit, over the interface, a notify of an observed event, the observed event indicating the backup battery status, the notify of the observed event being formatted according to the MGCP package protocol.

According to another embodiment, the observed event indicates the backup battery state and status of the backup battery unit that can be included in the gateway device.

According to yet another embodiment, when the gateway device receives the request-notification for the backup battery status, the processor changes from a battery-backup-notify-disable mode of not transmitting the notify of the observed event indicating the backup battery status to a backup-battery-notify-enable mode of enabling transmission of the notify of the observed event indicating the backup battery status.

According to a further embodiment, when the request-notification for the backup battery status is received and the gateway device includes a backup-battery unit that is on AC power, the observed event indicates a charge level of the backup battery unit.

According to a still further embodiment, when the request-notification for the backup battery status is received and the gateway device includes a back-up battery unit that is malfunctioning, the observed event indicates an error detected in the backup battery unit.

In yet another embodiment, when the request-notification for the backup battery status is received and the gateway device does not have a backup-battery unit, the observed event indicates that the gateway device does not have the backup-battery unit.

In another embodiment, when the request-notification for the backup battery status is received and the gateway device includes a backup-battery unit operating on back-up power, the observed event indicates an estimated duration of the backup-battery unit included in the gateway device.

Another embodiment provides a call agent device including an interface; and a processor cooperatively operable with the interface to transmit and receive packet communications over a communication network. The processor is configured to transmit, over the interface, a request-notification for a backup battery status, the request-notification being formatted according to an media gateway control protocol (MGCP) package protocol, and to receive, over the interface, a notify of an observed event over the interface, the observed event indicating the backup battery status, the notify of the observed event being formatted according to the MGCP package protocol.

According to another embodiment, when the call agent device receives the notify of the observed event indicating that the gateway is operating on back-up power, the processor changes from a non-battery-backup-mode of not managing power consumption at the gateway to backup-battery-mode of using low-power commands that allow the gateway to use reduced power; and when the call agent device receives the notify of the observed event indicating that the gateway is not operating on back-up power, the processor changes to the non-backup-battery-mode.

According to yet another embodiment, there are provided plural different policies for managing power consumption at different gateway devices, wherein one of the plural different policies for managing power consumption is selected depending on a type of the gateway and whether the gateway is in the battery-backup-mode or non-battery-backup-mode.

Still another embodiment provides a method for controlling power consumption of a gateway device. The method can include transmitting, from a call agent device to a gateway device, a request-notification for a backup battery status, the request-notification being formatted according to an media gateway control protocol (MGCP) package protocol; and receiving, at the call agent device from the gateway device, a notify of an observed event, the observed event indicating the backup battery state and status of the backup battery unit that can be included in the gateway device, the notify of the observed event being formatted according to the MGCP package protocol.

According to yet a still further embodiment, when the call agent device receives the notify of the observed event indicating that the gateway is operating on back-up power, changing from a non-battery-backup-mode of not managing power consumption at the gateway to backup-battery-mode of using low-power commands that allow the gateway to use reduced power; and when the call agent device receives the notify of the observed event indicating that the gateway is not operating on back-up power, changing to the non-backup-battery-mode.

In still another embodiment, the call agent includes plural different policies for managing power consumption at different gateway devices, and the call agent selects one of the plural different policies for managing power consumption depending on a type of the gateway and whether the gateway is in the battery-backup-mode or non-battery-backup-mode.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating portions of a gateway device;

FIG. 2 is a block diagram illustrating portions of a call agent device;

FIG. 3 is a protocol flow diagram;

FIG. 4 is a state diagram for the gateway device;

FIG. 5 is a state diagram for the call agent device; and

FIG. 6 is a flow chart illustrating a procedure to control power consumption of a gateway device.

### DETAILED DESCRIPTION

In overview, the present disclosure concerns gateways, call agents, and communication networks, often referred to as voice over packet (VOP) networks, such as may be associated with networks supporting voice communication. Such communication networks may provide additional services such as data communications, signal, and/or video services. Such networks can include network infrastructure devices, such as those providing or facilitating voice communications (such as edge routers, media gateways, centralized media gateways, session border controllers, trunk gateways, media boxes, call servers) which transfer the communications between endpoints, for example by forwarding the communications which may have been broken into communication packets. More particularly, various inventive concepts and principles are embodied in systems, devices, and methods therein for providing communications between a gateway and a call agent in a VOP network, to allow the call agent and gateway to communicate regarding a backup battery that may provide power to the gateway.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As further discussed herein below, various inventive principles and combinations thereof are advantageously employed to notify a call agent about the state of battery backup and current status. The MGCP package can provide a signaling interface for managing the health and operation of battery backup system and can complement and/or enhance the existing means such as SNMP.

Further in accordance with exemplary embodiments, an MGCP package is provided that defines the signaling interface used by a gateway, also referred to herein as a gateway device, to notify a call management server (CMS), also referred to herein as a call server or call server device, about state and mode of a battery backup unit (BBU) included with the gateway. The gateway can notify the CMS about a BBU management mode or state so that the CMS can use an appropriate policy/profile for the gateway such that the power consumption at the gateway is optimized. An MGCP package is defined for providing control over power consumption by a gateway that is using battery backup. The CMS can reduce power consumption by allowing the gateway to operate at lower CPU clock rate by choosing appropriate Local Connection Options (LCO), using ringing with lower duty cycle, ringing the phone for reduced duration, delaying VMMI notification, blocking certain calls and various such actions that will result in extending battery life.

The MGCP package format can be used to allow a gateway to transmit the state and status of the BBU. The MGCP package can allow a gateway to signal the call agent as to whether the BBU is operating (that is, charging), mode of operation (AC power or battery backup), time remaining until discharge, and/or similar.

Then, for example, a call agent can alert the operator about a malfunctioning BBU in a modem. If the modem switches to using battery, a call agent can monitor the charge and use an increasingly aggressive policy to conserve the power apart from using various options describe above.

The following events can be provided as part of this package:

| Symbol | Definition | R | S | Duration |
|---|---|---|---|---|
| st | BBU Status | x | | |
| ch( ) | Charging | | | |
| bp( ) | Using Backup power | | | |
| bf | Backup System Failure | | | |
| ba | Battery absent | | | |

When there is provided a backup battery unit (BBU) in the gateway, a small mechanism in the protocol permits information about the BBU to be provided to the network. There is nothing currently provided in the conventional MGCP protocol for the gateway to inform the call agent about the BBU. Currently, a call agent can poll the gateways or similar. However, polling does not scale very well when there are millions of gateways deployed.

Consider an example where a gateway determines to save power by reducing the clock rate. If the call agent is attempting to establish a call according to MGCP and is using, for example, a MIPS intensive CODEC such as low bit rate CODEC, then the gateway cannot operate at the lower clock rate and it tends to bump up the clock rate, and in that case the power consumption at the gateway will increase. If the information that the gateway is operating on a battery is available to the call agent, then the call agent can restrict the CODEC for the call to just a simple PCM, or similar.

There are other examples for reducing power consumption at the gateway, such as duty cycles for ringing. The duty cycles for ringing can be reduced, or the duration can be reduced, or only emergency calls can be permitted out of the gateway, and/or the call agent can simply block all incoming calls, to conserve the power for only emergency calls, or similar.

Hence, providing this information about the battery state at the call agent can increase the reliability and usability of the gateway. Nevertheless, the gateway cannot unilaterally take these actions to conserve power because the call agent controls the connection establishment and all of the parameters that go with it. If the gateway would unilaterally take these actions, the call agent might determine that there was an error.

In the MGCP package, both call agent and gateway are implemented so that the call agent has the option to collect the BBU status from the gateway; the gateway can inform the call agent whether it is charging, how much is the current charge level, malfunction of BBU, how much charge is left (how long it can continue to operate on the back up charge), and the like. Once this information is available to the call agent, the call agent can use the profile for the gateway so that the call agent can extend the gateway battery life, even to the fullest possible extent. The MGCP package described herein can provide a way for the call agent to instruct the gateway, that the gateway can tell the call agent about the battery.

Once the call agent has the information about the battery, there is nothing defined conventionally about the actions the call agent should take to conserve the gateway's battery power. For example, the call agent can allow the gateway to operate at lower CPU or to use local connection options. (Local connection options are known in the art and refer to, e.g., using a CODEC which does not require higher clock rate such as PCM using low bit rate CODEC). Similarly, with regard to ringing, adjusting duty cycle for ringing or various other things such as VMMI can delay for a certain time, etc.

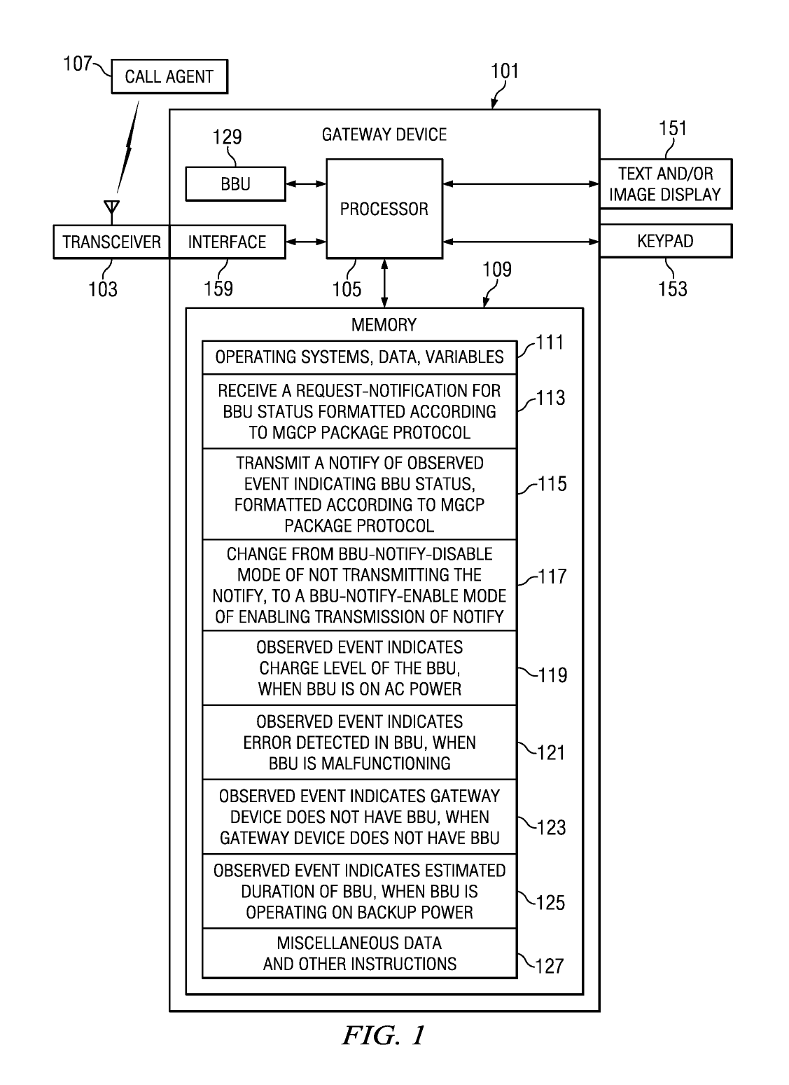

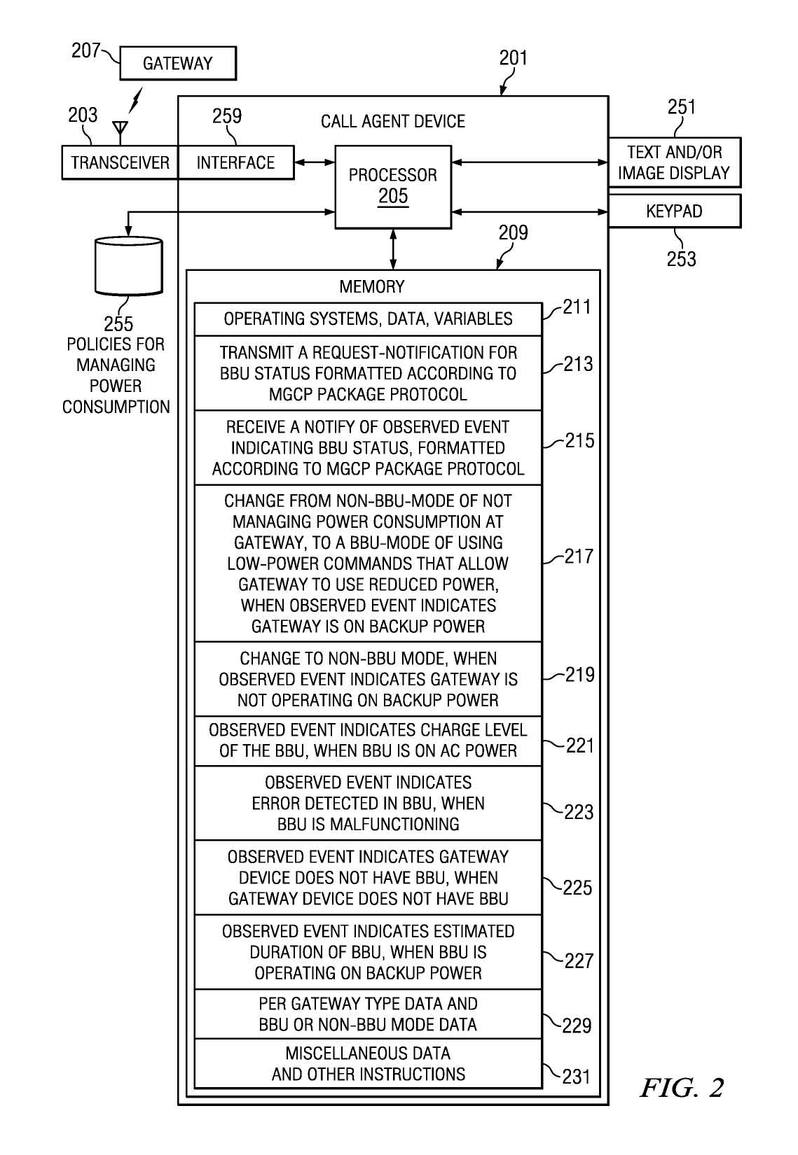

Relevant portions of a gateway device are illustrated in FIG. 1, and relevant portions of a call agent device are illustrated in FIG. 2.

Referring now to FIG. 1, a block diagram illustrating portions of a gateway device will be discussed and described. A gateway 101 is assigned, in the usual manner, a unique logical address value for the communication network, for example an IP address value. The gateway 101 may include a transceiver 103 and interface 159 for communicating over the communication network via a call agent 107. The transceiver 103 is representative of a combination of any number of transmitters and/or receivers, and may have a wireless or wired connection to the communication network via the call agent 107.

The gateway device 101 may include a processor 105, a memory 109, and other optional components which will be well understood to those in this field. A text and/or image display 151, a keypad 153, and/or other display and input device for interacting with the user, such as a track ball, console, keyboard, and/or similar optionally can be provided with the gateway 101. The gateway device 101 can include a BBU 129 that can inform the processor 105 of its status, as is known in the art.

The processor 105 may be, for example, one or more microprocessors and/or one or more digital signal processors. The memory 109 may be coupled to the processor 105 and may comprise a read-only memory (ROM), a random-access memory (RAM), a read/write flash memory, a programmable ROM (PROM), and/or an electrically erasable read-only memory (EEPROM). The memory 109 may include multiple memory locations for storing, among other things, an operating system, data and variables 111 for programs executed by the processor 105; computer programs for causing the processor to operate in connection with various functions such as to receive 113 a request-notification for BBU status, transmit 115 a notify of observed event indicating BBU status, change 117 from BBU-Notify-disabled mode to a BBU-notify-enable mode, observe 119 an event indicating charge level of the BBU, observe 121 an event indicating error detected in BBU, observe 123 an event indicating that the gateway device does not have the BBU, observe 125 an event indicating the estimated duration of the BBU, and/or other processing; and a database 127 for other information used by the processor 105. The computer programs may be stored, for example, in ROM or PROM and may direct the processor 105 in controlling the operation of the gateway device 101. The following discusses the functions in more detail.

The processor 105 may be programmed to as to receive 113 a request-notification for BBU status. The request-notification is formatted according to a conventional MGCP package protocol. The request notification indicates that BBU status is requested to be reported from the gateway, so that the gateway can report observed events that indicate the BBU status as predefined indicator in a notify of observed event transmission.

The processor 105 may be programmed to transmit 115 a notify of observed event indicating BBU status. The notify of observed event is formatted according to a conventional MGCP package protocol. The observed events which are reported to indicate BBU status are predefined to both the call agent and the gateway device, and can report BBU status and/or BBU events relating to the BBU 129 of the gateway device 101.

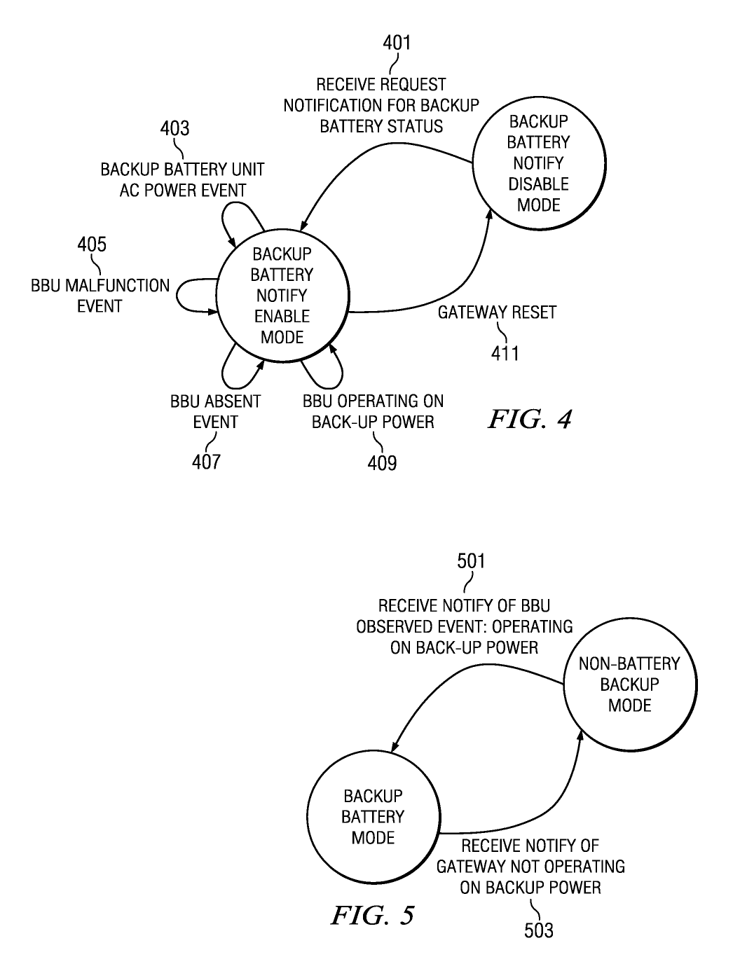

The processor 105 may be programmed to change 117 from BBU-notify-disabled mode to a BBU-notify-enable mode. In the BBU-notify-disabled mode, the gateway device 101 is in a mode of not transmitting the notify of observed event indicating BBU status, even when a BBU event or status occurs at the gateway device. The notify of observed event indicating BBU status can be transmitted any time subsequent to reception of the request-notification for BBU status, which indicates that the call agent 107 can receive observed events indicating BBU status. An example of changes between these modes is further discussed below in connection with FIG. 4. The gateway device 101 can be initialized, for example on power up, to the BBU-notify-disable mode.

Observed events indicating BBU status can include one or more of, for example, charge level of the BBU, that the BBU is on AC power, that the BBU is malfunctioning, that the gateway device does not have a BBU, that the BBU is operating on backup power, and estimated duration of BBU. The observed events indicating BBU status can correspond to BBU events or status which are conventionally collected at the gateway device 101 from the BBU 101 and optionally can be displayed at the gateway device 101, for example via the text and/or image display 151. Accordingly, it should be understood that the observed events indicating BBU status can be expanded or adapted to the BBU events or status which are actually collected at the gateway device 101.

The processor 105 may be programmed to observe 119 an event indicating a charge level of the BBU, when the BBU 129 is on AC power. The processor 105 may be programmed to observe 121 an event indicating error detected in BBU, when the BBU 129 is malfunctioning.

The processor 105 may be programmed to observe 123 an event indicating that the gateway device does not have the BBU, when the gateway device does not have the BBU 129.

The processor 105 may be programmed to observe 125 an event indicating the estimated duration of the BBU, when the BBU 129 is operating on backup power.

It should be understood that various embodiments of the gateway device 101 are described herein in connection with logical groupings of functions. One or more embodiments may omit one or more of these logical groupings. Likewise, in one or more embodiments, functions may be grouped differently, combined, or augmented.

Referring now to FIG. 2, a block diagram illustrating portions of a call agent device will be discussed and described. A call agent device 201 may include a transceiver 203 and interface 259 for communicating with a gateway 207; another transceiver (not illustrated) can allow the call agent device 201 to transmit and receive communications over a communication network. The transceiver 203 is representative of a combination of any number of transmitters and/or receivers, and may have a connection, typically wireless, to the gateway 207. The gateway 207 is representative of one, two or more gateways acting as slave with the call agent device 201 acting as master. The call agent device 201 may include a processor 205, a memory 209, and other optional components which will be well understood to those in this field. A text and/or image display 251, a keypad 253, and/or other display and input device for interacting with the user, such as a track ball, console, keyboard, and/or similar optionally can be provided with the call agent device 201.

The processor 205 may be, for example, one or more microprocessors and/or one or more digital signal processors. The memory 209 may be coupled to the processor 205 and may comprise a read-only memory (ROM), a random-access memory (RAM), a read/write flash memory, a programmable ROM (PROM), and/or an electrically erasable read-only memory (EEPROM). The memory 209 may include multiple memory locations for storing, among other things, an operating system, data and variables 211 for programs executed by the processor 205; computer programs for causing the processor to operate in connection with various functions such as to transmit 213 a request-notification for BBU status, receive 215 a notify of observed event indicating BBU status, change 217 from non-BBU mode of not managing power consumption at the gateway 207 to a BBU-mode of managing power consumption at the gateway 207, change 219 to non-BBU mode, observe 221 an event indicating charge level of the BBU, observe 223 an event indicating error detected in BBU, observe 225 an event indicating that the gateway device does not have the BBU, observe 227 an event indicating the estimated duration of the BBU, and/or other processing; a gateway database 229, table or similar for data regarding gateway type and BBU-mode; and a database 231 for other information used by the processor 105. The computer programs may be stored, for example, in ROM or PROM and may direct the processor 205 in controlling the operation of the call agent device 201. Also, the call agent device 201 may include remote or local storage for power consumption policies 255 for managing power consumption at gateways. Although the power consumption policies 255 are illustrated as a separately stored database, and the per-gateway type and BBU mode data 229 is illustrated as stored in memory 209, one of skill will appreciate that the data can be stored in memory 209, locally, or remotely, and can be formatted as a database, table or similar, and that other data can be included therein. The following discusses the functions in more detail.

The processor 205 may be programmed to as to transmit 213 a request-notification for BBU status to the gateway 207. The request-notification is the same as discussed in FIG. 1.

The processor 205 may be programmed to receive 215 a notify of observed event indicating BBU status. The notify of observed event is the same as discussed in FIG. 1.

The processor 205 may be programmed to change 217 from non-BBU-mode of not managing power consumption at the gateway 207, to a BBU-mode of managing power consumption at the gateway 207 such as by using low-power commands that allow the gateway 207 to use reduced power, when the observed event received from the gateway 207 indicates that the gateway 207 should conserve power such as being on backup power. It will be appreciated that the BBU-mode/non-BBU-mode of one gateway 207 can be different from the BBU-mode/non-BBU-mode of a different gateway 207 communicating with the same call agent device 201, such that the call agent device 201 can separately manage power consumption for different gateways. Also, the processor 205 may be programmed to change 219 to non-BBU mode, when an observed event from the gateway 207 indicates that the gateway 207 does not need to conserve power, such as when the gateway 207 is not operating on backup power.

The call agent device 201 expects to receive observed events indicating BBU status of the gateway 207 after the call agent device 201 has transmitted the request-notification for BBU status to the gateway 207. An example of changes between these modes is further discussed below in connection with FIG. 5. The call agent device 201 can internally indicate the initial mode of the gateway 207 as non-BBU-mode. The various observed events indicating BBU status are further discussed herein elsewhere.

The processor 205 may be programmed to observe 221 an event indicating a charge level of the BBU, which further informs the processor 205 that the gateway 207 is operating on AC power.

The processor 205 may be programmed to observe 223 an event indicating an error detected in the BBU of the gateway 207 as discussed further herein.

The processor 205 may be programmed to observe 225 an event indicating that the gateway 207 does not have the BBU, as further discussed herein.

The processor 205 may be programmed to observe 227 an event indicating the estimated duration of the BBU of the gateway 207, which further indicates that the gateway 207 is operating on backup power.

The gateway database 229 stores data for each of the gateways with which the call agent device 201 communicates, referred to herein as per-gateway data. The per-gateway data is specific to the individually address gateway and can indicate the general product type of the gateway 207 and the BBU-mode (which of non-BBU-mode and BBU-mode the gateway 207 is currently in).

Also, the call agent device 201 may include remote or local storage for different power consumption policies 255 for managing power consumption at gateways. Different product types of gateways can manage their power consumption differently, as discussed further herein. The power consumption policies can be provided so that the call agent device 201 can use different policies depending on, for example, the product type of the gateway 207.

It should be understood that various embodiments of the call agent 201 are described herein in connection with logical groupings of functions. One or more embodiments may omit one or more of these logical groupings. Likewise, in one or more embodiments, functions may be grouped differently, combined, or augmented.

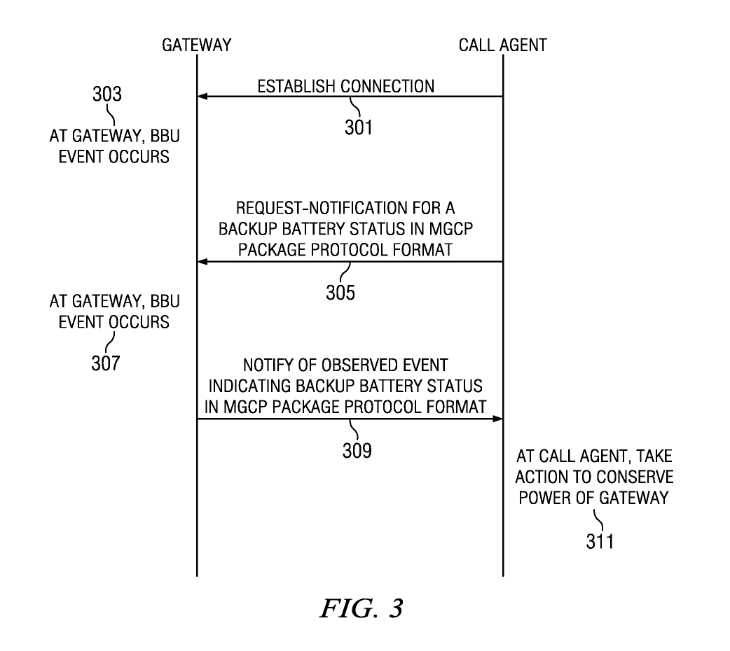

Referring now to FIG. 3, a protocol flow diagram will be discussed and described. In FIG. 3, the call agent transmits a request 301 to establish a connection to the gateway, in accordance with conventional techniques. At any time after establishing a connection between the gateway and the call agent, the call agent transmits 305 a request-notification for a backup battery status in MGP package protocol format, as discussed above. When a BBU event occurs 303 at the gateway before the request-notification for back-up battery status is received at the gateway, the gateway does not send a notify of observed event for the backup battery status. However, when a BBU event occurs 307 at the gateway after the request-notification for back-up battery status is received at the gateway, the gateway will transmit a notify 309 of observed event indicating backup battery status in MGCP package protocol format.

Once the call agent receives a notify 309 of observed event indicating that the gateway is operating on battery and hence cannot operate very long, the call agent can take action to conserve power of the gateway. For example, when a call to the gateway is routed through the call agent and the call agent can send a known instruction to create a connection to the gateway, the call agent can use one or more connection options which are known to conserve power, such as adjusting the PCN. Similarly, when the call agent tries to ring the gateway, the call agent can use connection options which are known to conserve power at the gateway, for example the ring control which controls the type of ringing can be selected by the call agent such that it is low duty cycle. That is, the call agent can prefer actions that conserve power at the gateway. These actions that take lower power at the gateway are generally known and/or which of two options uses lower power can be easily determined.

FIG. 4 and FIG. 5 are used to discuss example state tables of the gateway and the call agent concerning the mode that the gateway is operating in with respect to notifying the call agent about backup battery power.

Referring now to FIG. 4, a state diagram for the gateway device will be discussed and described. A gateway device can be in one of at least two modes, illustrated herein: backup battery notify disable mode, and backup battery notify enable mode. In the backup battery notify disable mode, backup battery events which can occur do not cause the gateway device to transmit information about the backup battery event or status. However, in the backup battery notify enable mode, backup battery events which can occur can cause the gateway device to transmit information about the backup battery event or status.

In this example, backup battery events include backup battery unit AC power event 403, BBU malfunction event 405, BBU absent event 407, and BBU operating on back-up power 409. Other events in this illustration include receive request notification for backup battery status 401, and gateway reset 411 (such as power-on, restart, hard reset, or similar).

In this illustration, a gateway is initially in the backup battery notify disable mode. Backup battery events which may occur in this mode can be ignored, or can cause no action to be taken. When in the backup battery notify disable mode, receiving a request notification for backup battery status 401 causes the state table to transition to the backup battery notify enable mode.

When the gateway is in the backup battery notify enable mode, BBU events can cause the gateway to take action to information the call agent of the BBU event or status, but the state remains the same, i.e., the backup battery notify enable mode. In this illustration, the backup battery unit AC power event 403 can cause the action of transmitting the notify event regarding the AC power to the call agent. The BBU malfunction event 405 can cause the action of transmitting the notify event of backup battery malfunction. The BBU absent event 407 can cause the action of transmitting the notify event of BBU absent. The BBU operating on back-up power 409 can cause the action of transmitting the notify event that the BBU is operating on back-up power. The gateway reset 411 (such as power-on, restart, hard reset, or similar) can cause the state to change to backup battery notify disable mode, optionally with some action such as indicating to the call agent according to known techniques that the gateway was reset.

Referring now to FIG. 5, a state diagram for the call agent device will be discussed and described. In this state diagram, two states are provided concerning the state which the call agent expects the gateway to be in: non-battery backup mode, and backup battery mode. In the non-battery backup mode, the gateway does not need to take actions which conserve power at the gateway. In the battery backup mode, the call agent can take actions that conserve power at the gateway. The call agent can store the state for each of the gateways with which it communicates.

Two events are of interest to this state diagram: receive 501 notify of a BBU observed event that the gateway is operating on back-up power, and receive 503 notify that the gateway is not operating on backup power. When the gateway is indicated as being in the non-battery backup mode and the call agent receives 501 from that gateway a notify of BBU observed event that the gateway is operating on back-up power, the state diagram transitions the gateway to the state of backup battery mode. When the gateway is indicated as being in the backup battery mode and the call agent receives 503 from that gateway a notify of gateway not operating on backup power, the state diagram transitions the gateway to the state of non-battery backup mode.

An example MGCP BBU package (also referred to as “the package”) is defined below.

(1) BBU status request event

A call agent can ask for BBU status to be detected, for example at any time. The request can be in the generic form of the basic MGCP package, as defined by the basic MGCP protocol RFC. In this example, the request indicates the BBU request notification by using “st” (BBU status) as the basic definition of this package. For example:

RQNT 1001 aaln/1@whatever.net MGCP 1.0

X: 1234

R: BBU/st, hu

where, according to standard format

RQNT is a standard indication of a command line request for notification

1001 is an example of a transaction identifier

aaln/1@whatever.net is an example of an endpoint address of the gateway

MGCP 1.0 is representative of a protocol and version number

X: 1234 is representative of a standard request identifier

R: is an example of a standard request event command which indicates that an MGCP command is to follow. The indication “BBU/st” is not conventional, though it can be in the form defined for MGCP package commands.

The indicator BBU/st command is not conventional, and indicates that the MGCP package command is for backup battery unit status. The acronym “BBU” could be some other acronym which similarly is a MGCP backup battery unit command. The “st” could be some other acronym and indicates that notification of the gateway's BBU status is requested by the call agent. The “hu” is representative other options which the call agent can include in the transmission to ask the gateway to detect, in this case, “hook event,” which can belong to other packages.

That is, the call agent has sent the gateway a request event command formatted according to the MGCP package, which includes a backup battery requested event, requesting that the gateway notify the call agent of the status of the backup battery unit. Then, the call agent will be in a mode with respect to the gateway which can receive the response with the backup battery state and status, in the MGCP package backup battery format.

A gateway can generate the event, such as “ch” or “bp” or “bf” or “ba” as the case may be, to indicate a current status of the BBU. The event can be informed from the gateway to the call agent, for example, using an Observed Event notification in an MGCP format.

(2) Backup battery status: charging status indication (e.g., ch). Charging status indication can indicate that the BBU is charging, can indicate that the gateway is on AC power, and can further include an indication of AC power level. For example, “/ch(lev=50)” can indicate that the BBU is charging, the gateway is on AC power, and the battery level is 50%. If the battery is fully charged, the AC power level can be specified as 100%.

A gateway that is in a default state, where the BBU is charging and is on AC power, can send notify to the call agent, for example as:
NTFY 1001 aaln/1@whatever.net MGCP 1.0
X: 1234
O: BBU/ch(lev=50)

(3) Backup battery status: failure status indication (e.g., bf). Failure status indication can indicate that the BBU is malfunctioning and/or that some kind of failure was detected in the BBU, and can further include an indication of type of failure if available from the gateway. For example, “/bf” can indicate that the BBU at the gateway is malfunctioning. A gateway where the BBU is malfunctioning can send notify to the call agent to indicate failure detected in the BBU, for example as:

NTFY 1001 aaln/1@whatever.net MGCP 1.0

X: 1234

O: BBU/ba

(4) Backup battery status: BBU Absent status indication (e.g., ba). A backup battery absent indication can be sent to indicate that the gateway has no BBU. A single call agent may send the same BBU status request to all of the gateways it communicates with, and some of those gateways might not have a BBU at all. A gateway with no BBU can send notify to the call agent to indicate that the gateway unit does not have the BBU, for example as:

NTFY 1001 aaln/1@whatever.net MGCP 1.0

X: 1234

O: BBU/ba

(5) Backup battery status: Backup power (e.g., bp). Backup power status indication can indicate that the gateway is operating on backup power, and can further indicate a duration of how long the gateway expects the BBU power to last (e.g., timeout value). The duration can be parameterized as minutes and/or seconds and/or hours, and/or end time, or the like. If the gateway was powering up and had a charge level of 10% (for example) and suddenly the power went off, the gateway can notify of backup power with a timeout value of, e.g., 30 minutes. If the gateway was fully charged when the power went out, the timeout value might be five or six hours of estimated battery lifetime.

In this example, the timeout value is estimated battery lifetime in minutes that the gateway expects to operate on backup power. A gateway that is operating on backup power can notify the call agent that it is operating on battery backup power as well as the parameterized estimated duration of the power, for example, as:

NTFY 1001 aaln/1@whatever.net MGCP 1.0

O: BBU/bp(to =3600)

where 3600 represents the minutes of estimated battery lifetime on backup power.

The gateway can send the response to the call agent whenever it detects that the event happens. For example, when the BBU begins malfunctioning, the gateway can send the response to the call agent indicating the BBU malfunction. Thus, the gateway can notify the call agent when a status change happens or whenever the need arises to manage gateway power conservation.

The package discussed herein can allow management of the BBU via signaling between the call agent and the gateway, thereby reducing the need for operators to monitor or poll modems via other means to ensure the health of the system.

In addition, the package can allow a call management system (CMS) to implement different policies such that power consumption can be minimized and battery life extended. The aggressiveness of these policies can change depending on the type of BBU in the modem and the amount of battery charge remaining

The package can provide a unique advantage by allowing seamless management of different modems, battery-capacity, and/or current level, and the like.

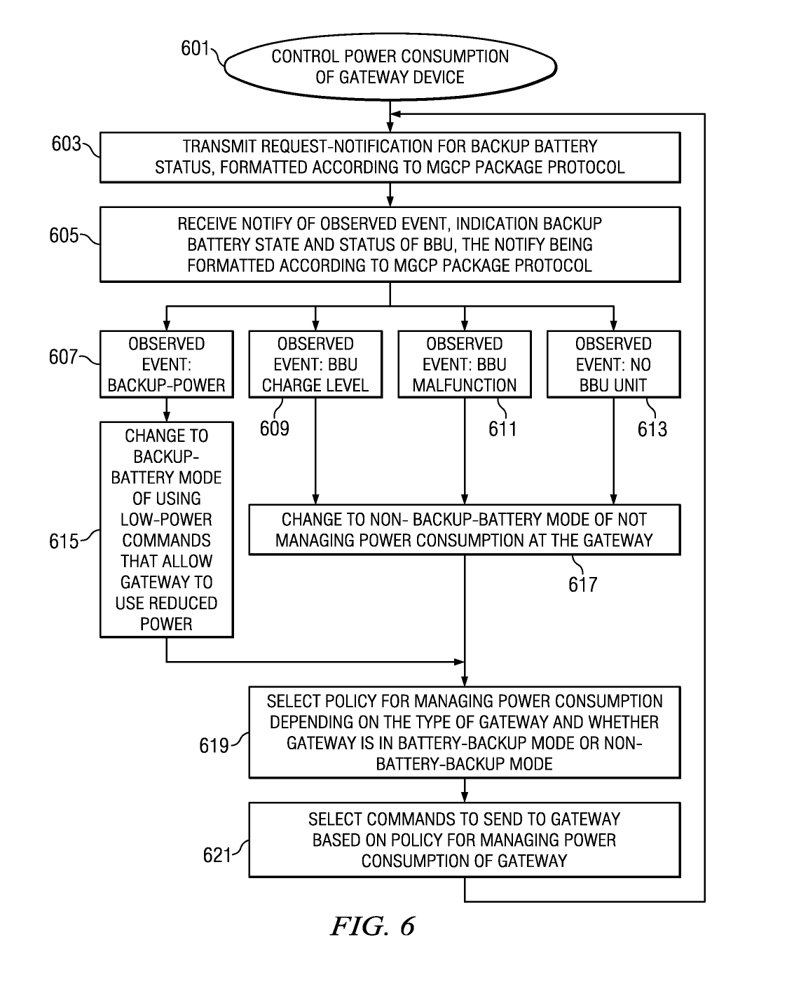

Referring now to FIG. 6, a flow chart illustrating a procedure to control power consumption of a gateway device will be discussed and described. The procedure can advantageously be implemented on, for example, a processor of a gateway device, described in connection with FIG. 1, or a processor of a call agent device, described in connection with FIG. 2, or both, or other apparatus appropriately arranged. Controlling power consumption is sometimes referred to herein as “conserving” power.

In overview, the procedure 601 to control power consumption of a gateway device includes transmitting 603 a request-notification for backup battery status; receiving 605 notification of an observed event indicating backup battery state and status of BBU (the observed event being backup-power 607, BBU charge level 609, BBU malfunction 611, or no BBU unit 613); changing to back-up battery mode when the observed event is back-up power; or changing to non-backup-battery mode for the other observed events; selecting 619 the power consumption management policy depending on the type and mode of the gateway; and selecting 621 commands to send to the gateway based on the policy for managing power consumption for that particular gateway. Each of these will now be described in some more detail, omitting specifics which have been described elsewhere in this document.

The procedure 601 includes transmitting 603 a request-notification for backup battery status, formatted according to the MGCP package protocol definition. The request-notification for backup battery status indicates that observed events regarding the backup battery status can be informed and that power consumption can be controlled thereafter.

The procedure 601 includes receiving 605 notification of an observed event indicating backup battery state and status of BBU, as further described above. In this example, the observed event can be backup-power 607, BBU charge level 609, BBU malfunction 611, or no BBU unit 613. Backup battery power is being used if the observed event is backup-power. In that situation, it can be desirable to reduce power consumption at the gateway. Hence, the procedure 601 provides for changing to back-up battery mode when the observed event is back-up power. If the observed event indicates the BBU charge level 609 (further indicating that AC power is in use), that the BBU malfunctioned 611 (suggesting that the BBU is not properly operating), or that there is no BBU unit 613 (and hence no need to conserve BBU power), the procedure 601 can provide for changing 617 to non-backup-battery mode which operates as described above.

The procedure 601 then can select 619 the power consumption management policy depending on the type and mode of the gateway. Different power consumption management policies can indicate which commands to send or to not send. That is, a power consumption management policy for battery-backup mode can use short-duration ringing commands, or other power conservation measures, which are appropriate for each different product type of gateway.

The procedure 610 can select 621 commands to send to the gateway based on the policy for managing power consumption for that particular gateway. The power consumption management policy can indicate which commands to send or to not send depending on the backup-battery mode of the gateway, depending on the commands that are supported for the type of the gateway. Accordingly, if a gateway is in backup-battery mode and supports short-duration ringing, a call agent can send a conventional command for short-duration ringing instead of a normal ring, based on the policy for managing power consumption which was selected for the gateway by the procedure 601.

It should be noted that the communication networks of interest include those that transmit information in packets, for example, those known as packet switching networks, more particularly using VOP (voice over packet) protocol, and even more particularly using VoIP (voice over IP) protocol, and even more particularly using SIP-formatted packets. Such networks can include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

The terms “call agent” and “gateway” as used herein are defined as the master and the slave, respectively, in a server client protocol referred to as “media gateway control protocol” architecture, in a VOP or VoIP system that sometimes interoperates with the public switched telephone network (PSTN), as further defined in a Media Gateway Control Protocol such as by RFC 2805 (Media Gateway Control Protocol Architecture), RFC 3435 (which supersedes RFC 2705) (Media Gateway Control Protocol (MGCP) Version 1.0), and variations and evolutions thereof.

The term “gateway” is used above in the detailed description and in the claims to further specifically mean any of various network devices providing or communicating on VOP networks, that is, a hardware device connecting an internal network with a wide area network (WAN) or the Internet; the gateway can use MGCP to communicate with the call agent. Such devices are sometimes colloquially referred to as “media gateway,” “residential gateways,” “home gateways,” “home routers,” or “broadband routers.” The designation “VoIP gateway” is used herein to indicate such a gateway specifically including functionality to communicate using VoIP.

The term “call agent,” also sometimes referred to as a “media gateway controller” or “MGC”, can perform conversion of media signals between circuits and packets, using MGCP to inform the gateway at least of what events should be reported to the call agent, and the gateway can use MGCP to report events such as off-hook or dialed digits to the call agent. The designation “VoIP call agent” is used herein to indicate such a call agent specifically including functionality to communicate using VoIP.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A gateway device, comprising:
an interface; and
a processor cooperatively operable with the interface to transmit and receive packet communications over a communication network, the processor configured:
to receive, over the interface, a request-notification for a backup battery status, the request-notification being formatted according to an media gateway control protocol (MGCP) package protocol, and
to transmit, over the interface, a notify of an observed event, the observed event indicating the backup battery status, the notify of the observed event being formatted according to the MGCP package protocol.

2. The gateway device of claim 1, the observed event indicating the backup battery state and status of the backup battery unit that can be included in the gateway device.

3. The gateway device of claim 1,
when the gateway device receives the request-notification for the backup battery status, the processor changes from a battery-backup-notify-disable mode of not transmitting the notify of the observed event indicating the backup battery status to a backup-battery-notify-enable mode of enabling transmission of the notify of the observed event indicating the backup battery status.

4. The gateway device of claim 1,
when the request-notification for the backup battery status is received and the gateway device includes a backup-battery unit that is on AC power, the observed event indicates a charge level of the backup battery unit.

5. The gateway device of claim 1,
when the request-notification for the backup battery status is received and the gateway device includes a back-up battery unit that is malfunctioning, the observed event indicates an error detected in the backup battery unit.

6. The gateway device of claim 1,
when the request-notification for the backup battery status is received and the gateway device does not have a backup-battery unit, the observed event indicates that the gateway device does not have the backup-battery unit.

7. The gateway device of claim 1,
when the request-notification for the backup battery status is received and the gateway device includes a backup-battery unit operating on back-up power, the observed event indicates an estimated duration of the backup-battery unit included in the gateway device.

8. A call agent device, comprising:
an interface; and
a processor cooperatively operable with the interface to transmit and receive packet communications over a communication network, the processor configured:
to transmit, over the interface, a request-notification for a backup battery status, the request-notification being formatted according to an media gateway control protocol (MGCP) package protocol, and
to receive, over the interface, a notify of an observed event over the interface, the observed event indicating the backup battery status, the notify of the observed event being formatted according to the MGCP package protocol.

9. The call agent device of claim 8, the observed event indicating the backup battery state and status of the backup battery unit that can be included in the gateway device.

10. The call agent device of claim 8,
when the call agent device receives the notify of the observed event indicating that the gateway is operating on back-up power, the processor changes from a non-battery-backup-mode of not managing power consumption at the gateway to backup-battery-mode of using low-power commands that allow the gateway to use reduced power,
when the call agent device receives the notify of the observed event indicating that the gateway is not operating on back-up power, the processor changes to the non-backup-battery-mode.

11. The call agent device of claim 10, the processor being further configured with plural different policies for managing power consumption at different gateway devices, wherein one of the plural different policies for managing power consumption is selected depending on a type of the gateway and whether the gateway is in the battery-backup-mode or non-battery-backup-mode.

12. The call agent device of claim 8,
the observed event indicating a charge level of the backup battery unit when the request-notification for the backup battery status was transmitted and the gateway device includes a backup-battery unit that is on AC power.

13. The call agent device of claim 8,
the observed event indicating an error detected in the backup battery unit when the request-notification for the backup battery status was transmitted and the gateway device includes a back-up battery unit that is malfunctioning.

14. The call agent device of claim 8,
the observed event indicating that the gateway device does not have the backup-battery unit when the request-notification for the backup battery status was transmitted and the gateway device does not have a backup-battery unit.

15. The call agent device of claim 8,
the observed event indicating an estimated duration of the backup battery unit included in the gateway device when the request-notification for the backup battery status was transmitted and the gateway device includes a backup-battery unit operating on back-up power.

16. A method for controlling power consumption of a gateway device, comprising:
transmitting, from a call agent device to a gateway device, a request-notification for a backup battery status, the request-notification being formatted according to an media gateway control protocol (MGCP) package protocol; and
receiving, at the call agent device from the gateway device, a notify of an observed event, the observed event indicating the backup battery state and status of the backup battery unit that can be included in the gateway device, the notify of the observed event being formatted according to the MGCP package protocol.

17. The method of claim 16,
when the call agent device receives the notify of the observed event indicating that the gateway is operating on back-up power, changing from a non-battery-backup-mode of not managing power consumption at the gateway to backup-battery-mode of using low-power commands that allow the gateway to use reduced power,
when the call agent device receives the notify of the observed event indicating that the gateway is not operating on back-up power, changing to the non-backup-battery-mode.

18. The method of claim 17, the call agent including plural different policies for managing power consumption at different gateway devices, further comprising selecting one of the plural different policies for managing power consumption depending on a type of the gateway and whether the gateway is in the battery-backup-mode or non-battery-backup-mode.

19. The method of claim 16,
the observed event indicating a charge level of the backup battery unit of the gateway device when the gateway device includes a backup-battery unit that is on AC power, or indicating an error detected in the backup battery unit when the gateway device includes a back-up battery unit that is malfunctioning.

20. The method of claim 16,
the observed event indicating that the gateway device does not have the backup-battery unit when the gateway device does not have a backup-battery, or indicating an estimated duration of the backup battery unit included in the gateway device when the gateway device includes a backup-battery unit operating on back-up power.
